(19) United States
(12) Patent Application Publication
(10) Pub. No.: US 2010/0023366 A1
(43) Pub. Date: Jan. 28, 2010

(54) Process and apparatus for comprehensive configuration valid bill of material planning and auditing

(75) Inventors: Daniel J. Budnik, Southington, CT (US); Shih-Lien Leon Chu, Enfield, CT (US)

Correspondence Address: BACHMAN & LAPOINTE, P.C. (P&W), 900 CHAPEL STREET, SUITE 1201, NEW HAVEN, CT, 06510-2802, US

(73) Assignee: United Technologies Corporation

(21) Appl. No.: 11/809,660

(22) Filed: May 31, 2007

(51) Int. Cl. G06Q 10/00; G06Q 50/00

(52) U.S. Cl. 705/8; 705/29; 705/7

(57) ABSTRACT

A computer-implemented process for planning a configuration valid bill of materials for a product includes the steps of inputting at least one MOD from a MOD list into a planning module to generate a part genealogy of a product; identifying a senior MOD of the MOD list based upon a progression level value and a ranking value for at least one location identifier; determining a shortest path in the part genealogy from at least one base part of the product to the senior MOD for the at least one location identifier; identifying a complete progression from each of the at least one base parts to each corresponding at least one senior MODs for each of the at least one location identifiers; generating a configuration valid bill of materials for the product; and conveying the configuration valid bill of materials.

### TECHNICAL FIELD

The disclosure relates to configuration valid bills of material and, more particularly, the disclosure relates to process(es) and apparatus for configuration valid bills of material planning and auditing.

### BACKGROUND OF THE INVENTION

A maintenance facility can perform a variety of operations on an engine. While performing these maintenance operations, the maintenance facility must ensure that the engine retains a valid configuration. In other words, the maintenance facility must verify that each part used in the engine is compatible with the other parts used in the engine. This process is known as configuration management.

While simple in theory, real life configuration management creates a daunting task for the maintenance facility. Configuration management becomes increasingly convoluted with the successive complexity of the maintenance operation. Maintenance operations include, in increasing order of complexity, maintenance, repair and overhaul.

Conventional configuration management is so complex during an overhaul that maintenance facilities perform the process manually. In fact, maintenance facilities often use several individuals to perform this task. The individuals performing configuration management typically consult several discrete sources of information. These sources include Engine Manuals, Illustrated Parts Catalogs and Service Bulletins. These sources of information are either hard copies or electronic versions of the hard copy. By manually cross-referencing these discrete sources, the individuals ensure that each part selected for reinstallation in the engine is proper and is compatible with the remaining parts.

However, such manual configuration management consumes a significant amount of time. In light of the increased time constraints placed on the maintenance facility during an overhaul, a desire exists for a replacement process that is quicker than conventional manual configuration management.

Conventional manual configuration management also requires multiple audits to ensure accuracy. Clearly, a desire exists for a replacement process that does not require such multiple audits.

Furthermore, conventional manual configuration management is incapable of repeatability. A maintenance facility performing the same maintenance operation on two identical engines would need to perform the same time consuming configuration management research twice. The individuals performing the research on the first engine cannot transfer this knowledge under the current manual process to the research for the second engine. Clearly, a desire exists for a replacement process that is repeatable.

Finally, conventional manual configuration management may not produce consistent results. For example, different individuals may interpret information contained within a Service Bulletin differently. These different interpretations may result in the issuance of different work instructions for an identical procedure. Therefore, a desire exists for a replacement process that provides consistent results.

### SUMMARY OF THE INVENTION

In accordance with one aspect of the present invention, a computer-implemented process for planning a configuration valid bill of materials for a product broadly comprises inputting at least one MOD from a MOD list into a planning module to generate a part genealogy of a product; identifying a senior MOD of the MOD list based upon a progression level value and a ranking value for at least one location identifier; determining a shortest path in the part genealogy from at least one base-part of the product to the senior MOD for the at least one location identifier; identifying a complete progression from each of the at least one base parts to each corresponding at least one senior MODs for each of the at least one location identifiers; generating a configuration valid bill of materials for the product; and conveying the configuration valid bill of materials.

In another aspect of the present invention, a computer-implemented process for auditing a bill of material of a product broadly comprises dispositioning at least one serviceable part of a product; inputting into an auditing module at least one configuration valid part as determined from a configuration valid bill of materials for the product; determining a status of each of the at least one serviceable part and the at least one configuration valid part; and conveying an audited MOD list.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 a representation of a system for use in implementing the exemplary configuration management tool described herein;

FIG. 2 is a flow chart representing the steps in performing the process of the exemplary configuration management tool described herein;

FIG. 3 is a representation of a screen shot for use in the performance of planning a Bill of Materials by the configuration management tool of the present disclosure;

FIGS. 4a and 4b are representations of screen shots for use in the discovery of a sourcing problem by the configuration management tool of the present disclosure;

FIG. 5 is a representation of a screen shot for use in the search for alternate parts by the configuration management tool of the present disclosure;

FIG. 6 is a representation of a screen shot for use in providing alternate part information by the configuration management tool of the present disclosure;

FIG. 7 is a representation of a screen shot for use in conducting an audit of a BOM by the configuration management tool of the present disclosure;

FIG. 8 is a representation of a screen shot for use in filtering information during the audit conducted using the configuration management tool of the present disclosure;

FIG. 9 is a representation of a screen shot for use in reviewing the MOD list during the audit conducted using the configuration management tool of the present disclosure;

FIG. 10 is a representation of a screen shot of a message indicating the cause of a missing service bulletin during the audit conducted using the configuration management tool of the present disclosure;

FIG. 11 is a representation of a screen shot of another message indicating the cause of a missing service bulletin during the audit conducted using the configuration management tool of the present disclosure;

FIG. 12 is a representation of a screen shot of another message indicating the cause of a missing service bulletin during the audit conducted using the configuration management tool of the present disclosure; and

FIG. 13 is a representation of a screen shot of another message indicating the cause of a missing service bulletin during the audit conducted using the configuration management tool of the present disclosure.

Like reference numbers and designations in the various drawings indicate like elements.

### DETAILED DESCRIPTION

While the processes and apparatus of the present disclosure could be used to manage any type of inventory, the following description refers specifically to the management of aircraft engine parts.

The following terms and phrases will be used throughout the specification.

A Bill of Material (BOM) refers to a list of components that define a product, such as a gas turbine engine.

A Master Parts List or Grand BOM refers to a list of all potential parts that could be used in the product.

An As-Built BOM refers to a list of parts used by the Original Equipment Manufacturer (OEM) or the maintenance facility to assemble the product.

A Planned BOM refers to a list of technical bulletins, e.g., service bulletins, and other configuration management documents that are collectively referred to as MODS, which have already been incorporated or require incorporation into a product at the maintenance facility prior to releasing the product.

An As-Shipped BOM refers to a list of parts in the product when the OEM or the maintenance facility releases the product. Since the product may undergo testing after assembly, the As-Shipped BOM may not be the same as the As-Built BOM. If testing proves successful, the OEM or the maintenance facility releases the product engine and the As-Shipped BOM will mirror the As-Built BOM. If testing proves unsuccessful, the OEM or the maintenance facility may replace parts on the product and perform additional testing. If the OEM or the maintenance facility replaces parts, the As-Shipped BOM will not be the same as the As-Built BOM.

An As-Received Configuration refers to a list of parts found in the product by the maintenance facility during disassembly. If the maintenance facility performed the previous maintenance operation, then the As-Received Configuration will be the same as the As-Shipped BOM.

A Planned Configuration refers to a preliminary list of parts selected by the maintenance facility for reassembly into the product.

A Should Build Configuration refers to a list of parts selected by the maintenance for reassembly into the product.

An Engine Manual refers to a publication that contains OEM and aviation authority (e.g. Federal Aviation Administration, Joint Aviation Authority, etc. ) approved engine maintenance procedures.

Illustrated Parts Catalog refers to a publication that provides part numbers and illustrations for parts used to manufacture an engine and for replacement parts.

A Service Bulletin refers to a publication containing OEM and aviation authority approved technical data for incorporating an engineering change into an existing engine. The Service Bulletin includes work instructions necessary to incorporate the engineering change into the engine.

An Add Parts List refers to the parts that the Service Bulletin can add to the engine.

A Cancel Parts List refers to the parts that the Service Bulletin can remove from the engine.

A SETS Requirement refers to a stipulation in the Service Bulletin that all of the parts on the Add Parts List must be added to the engine and that all of the parts on the Cancel Parts List must be removed from the engine. In other words, a Sets Requirement prohibits partial incorporation of the Service Bulletin.

A Prerequisite Service Bulletin refers to a Service Bulletin already incorporated into an engine before a maintenance facility performs the subject Service Bulletin. Typically, the subject Service Bulletin reworks some of the changes made by the Prerequisite Service Bulletin.

A Concurrent Service Bulletin refers to a Service Bulletin that a maintenance facility must accomplish at least simultaneously with the subject Service Bulletin.

A Superseding Service Bulletin refers to a Service Bulletin that replaces the subject Service Bulletin.

A Recommended Service Bulletin refers to a Service Bulletin that a maintenance facility should accomplish along with the subject Service Bulletin in order to gain maximum benefit of the Service Bulletins.

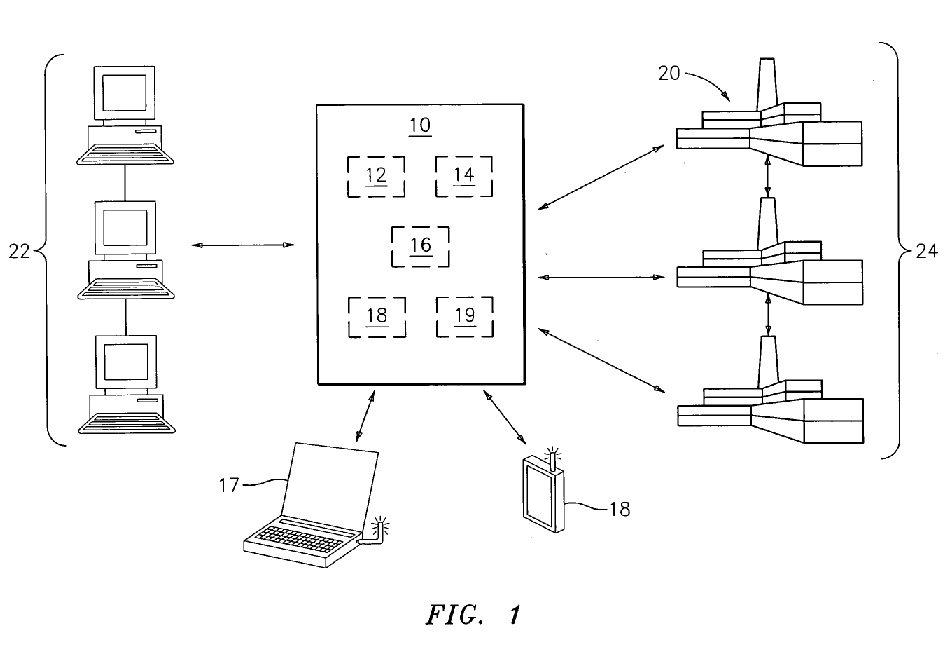

Referring now to FIGS. 1-13, the configuration management tool described herein may generate a configuration valid Planned BOM using historical and the current modification scope service bulletins. The configuration management tool described herein incorporates ranking and progression levels into a part genealogy, the family of parts and their progression relationship at a given LID of a particular engine model group.

In one representative embodiment, a computer system, e.g., a host server with client computer, a computer, personal digital assistant, and the like, may be equipped with software embodying the computer-implemented process of the configuration management tool such that the computer system itself becomes the configuration management tool. For example, the software may be commercially available from SAP America, Inc., Newtown Square, Pa. The computer system embodying the configuration management tool described herein may include at least a planning module and an auditing module for carrying out the computer-implemented process. FIG. 1 illustrates a representative system having a server 10 embodying the hardware for computer-implemented process, e.g., planning module 12, auditing module 14, planned configuration database 16, analysis module 18, SB database 19. The server 10 may include an input device, such as a computer, and a means for connecting serially to a computer 17, a personal digital assistant 18, and/or a maintenance facility 20, and/or a means for connecting in parallel to a plurality of computers 22 and/or a plurality of maintenance facilities 24. As illustrated, the connections amongst the devices may be hard wired or wirelessly connected as known to one of ordinary skill in the art. The user of the configuration management tool described herein may implement the process and apparatus on-site at the maintenance facility 20, at their office, or at another location off-site.

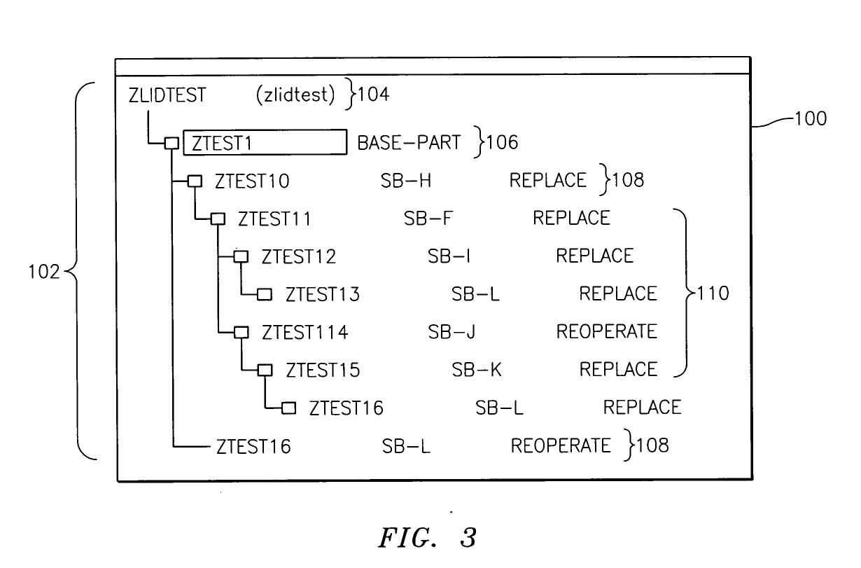

Referring now to FIG. 3, a representative screen 100 generated by a planning module to assist the maintenance facility in generating the Planned BOM is illustrated. The aftermarket BOM of a gas turbine engine generally comprises an inverted tree structure as displayed in FIG. 3; however, any other suitable arrangement may be used. Screen 100 may include an inverted tree structure 102 having a first (N^{th}) level displaying a modules group section 104, a second (N^{th}+1) level displaying a constituent assemblies section 106, a third (N^{th}+2) level displaying a subassemblies section 108, and an fourth (N^{th}+X) level displaying a detail piece part section 110.

Each location, i.e., node, within the inverted tree structure where a particular part number is required, that is, assembly part number, subassembly part number, detail part number, etc., is designated by an identifier termed a location ID (“LID”). During a conventional BOM planning process, a specific part number is assigned to each LID. There may be multiple part numbers which may occupy each LID of an engine structure throughout the history of the engine. At the time of the first production release of the engine, the Base Configuration part number, that is, the base-part, would be assigned to each LID within the engine structure. Following this, SBs may change the specific part number required at the LID.

The BOM planning process described herein involves selecting the appropriate part number to be placed at each LID per the configuration level specified within the MOD list for the engine. The entire family of parts at each LID along with the configuration rules guiding their use is identified as the Master BOM and is contained within the configuration management tool of the present invention. In order to approximately determine the correct material to be placed at the LIDs in the engine BOM structure affected by SBs, the planning module 12 of the configuration management tool utilizes both a rank level and a progression level that relate to part genealogy and BOM planning. The rank levels and progression levels may be automatically maintained, updated, and monitored during the Master BOM maintenance process, e.g., with the addition or withdrawal of SBs, within the configuration management tool described herein.

The rank level permits the maintenance facility to determine which SB is the latest SB and also identify the correct part number. By definition, there is a single rank number for a given material and service bulletin combination within a LID genealogy. The rank number is the maximum level of indenture for that material and service bulletin combination within a LID genealogy tree structure 102. For example, within the part genealogy tree of FIG. 3, there are three records associated with the “SB-L” and add part “ZTEST 16”. On the record where “ZTEST 16” replaces “ZTEST 15”, the rank is assigned “6”, i.e., six levels of indent from the Base Configuration material. On the record where “ZTEST 16” is re-operated from “ZTEST 1”, the rank remains “6”. When multiple SBs appear in the MOD list for a given LID, then the SB which requires planning for that LID is the SB with the highest rank value.

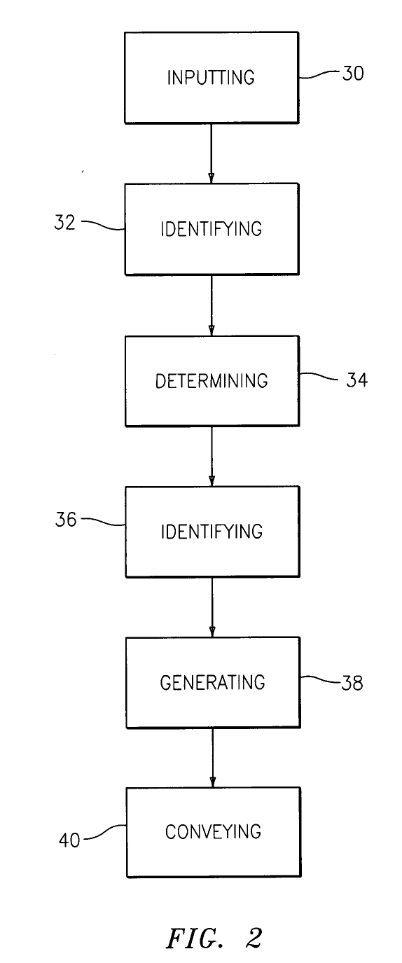

The progression level is the level of indenture for each part number and service bulletin combination within the LID genealogy tree. In order to successfully plan a BOM taking into account all of the interdependencies found within the master technical data, the BOM planning process mandates that the MOD list contain a set of SBs at each LID which enables progression of the part numbers from the Base Configuration engine to the current MOD, that is, the senior MOD, or SB level intended for the engine. The senior MOD may be identified based upon a progression level value and a ranking value of the LID at a step 32 of FIG. 2. If this is not possible, then a “Broken Progression” occurs. A “Broken Progression” as known in the art, is a violation of the part progression genealogy rules and requires resolution before BOM planning may proceed. Unlike the Ranking value, a given part and SB combination may have multiple progression levels as a consequence of the progression of that material and SB combination within the genealogy tree. For example, in the genealogy tree structure 102 of FIG. 3, there are three records associated with “SB-L” and add part “ZTEST 16”. On the record where “ZTEST 16” is replaces “ZTEST 15”, the progression level is assigned “6”. On the record where “ZTEST 16” is reoperated from “ZTEST 1” the progression level is assigned “2”. In addition, the records with “ZTEST 13” replacing “ZTEST 12” is assigned a progression level value of “5”. This exercise is representative of determining the shortest path in the part genealogy from a base-part to the senior MOD for the LID at step 34 of FIG. 2.

When planning a BOM, the maintenance facility may discover a sourcing problem with one or more of the parts intended for installation in the engine. Generally, sourcing problems could include an unfillable order, part unavailability, excessive lead-time, high part price and the like, as understood by one of ordinary skill in the art.

The configuration management tool described herein notifies the maintenance facility of this sourcing problem after comparing the Planned Configuration database 16 to a database (not shown) of parts affected by the sourcing problem(s). In the alternative, the maintenance facility could also learn of the sourcing problem(s) without the configuration management tool described herein, for example, sourcing problems that have occurred after the most recent update of the database. However, the configuration management tool is designed in part to prevent such an occurrence.

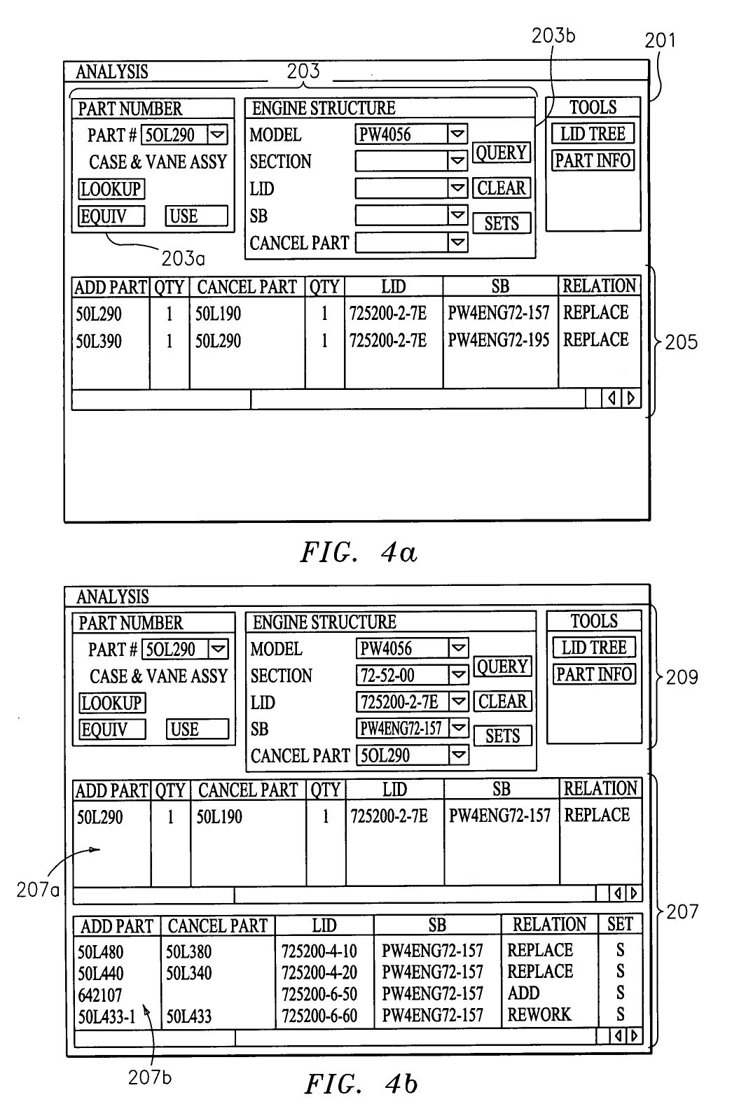

FIG. 4a displays a screen 201 generated by an analysis module 18 of the configuration management tool to assist a maintenance facility upon discovering a sourcing problem. The screen 201 could include an input section 203 and a results section 205; however, any other suitable arrangement may be used as understood by one of ordinary skill in the art. The various sections will be described in more detail below.

The input section 203 of the screen 201 preferably allows user(s) to enter part-specific information in box 203a or more generalized information in box 203b. However, the configuration management tool could use any type of information sufficient to assist the user in modifying the work scope. The user may input the desired information using, for example, the computer 17, or the user could select options appearing in a drop-down box at a step 30 of FIG. 2. For example, the program may pre-populate the input section 203 with information from the Planned Configuration database 16 of the configuration management tool described herein.

The configuration management tool may search an SB database 19 for instances of the information provided by the user to the input section 203. The program may display the results of such query in the results section 205. If no SB introduced the part, that is, no data appears in the results section 205, the subject part may then be considered a basic part. Generally, a basic part is a part installed during the original assembly of the engine, that is, the part is reflected in the As-Built BOM.

If the desired part number appears in more than one SB for example, in an Add Parts List of one SB and in the Cancel Parts List in another SB, the user must then specify one of the SBs before proceeding.

Before choosing an SB, the user can obtain additional information regarding the SBs while in screen 201. For example, box 201b allows the user to obtain information regarding Sets Requirements, Sets/Stage Requirements or Optional Dependency by clicking the Sets button. The configuration management tool displays such information by opening another window (not shown).

A Sets Requirement requires the replacement of every part on a Cancel Parts List of the SB with the parts on the Add Parts List of the SB. In other words, a Sets Requirement prohibits intermixing of parts from the Add Parts List with parts from the Cancelled Parts List.

As understood by one of ordinary skill in the art, a Sets/Stage Requirement differs from a Sets Requirement. A Sets/Stage Requirement may arise when an SB deals with the same part number at multiple locations within the engine. The Sets/Stage Requirement allows partial incorporation of the SB by replacing all of the subject parts at one location within the engine. For example, a Sets/Stage Requirement may allow the maintenance facility to replace all of the compressor blades from the fifth stage, without replacing the sixth stage blades. The maintenance facility may then fully incorporate the SB during a subsequent maintenance visit by replacing the sixth stage blades.

Optional Dependency differs from both a Sets Requirement and a Sets/Stage Requirement. An Optional Dependency indicates related parts within the Add Parts List. For example, a ring segment assembly composed of vane assemblies and pins typifies related parts within an SB. When an Optional Dependency exists, the configuration management tool described herein may display the options available for all of the related parts as a group.

The configuration management tool may use a Location Identifier (LID) to designate a specific location for a part in the engine, since a given part number could reside at multiple locations in the engine. The LID has five fields. The first three fields follow Air Transport Association (ATA) Specification 100 standards. That is, the first three fields of the LID refer to ATA Chapter, Section and Subject. Dashes separate the first three fields from the fourth field and the fourth field from the fifth field. The fourth and fifth fields equate to the IPC Figure and Item Number that display the part.

The screen 201 also includes a tools box 209. In the tools box 209, the user may obtain additional information regarding the selected part. Specifically, the user may obtain information regarding optional parts for the current SB level. Optional part information lists interchangeable parts, that is, direct substitutes; alternate parts, for example, parts, such as clamps, that are usable even if undersized or oversized from the desired size; and, preferred parts, that is, the choice of one interchangeable part over another interchangeable part, for the current SB level. The configuration management tool may also provide the user with information regarding sourcing problems such as by querying a sourcing problems database (not shown). The program provides this additional information by opening a new window (not shown).

The program obtains this information by querying an IPC database (not shown) on the server 10. The IPC database preferably includes an electronic version of the hard copy IPC, for example, in HTML format, for viewing upon request by the user and a version of the IPC in a codification understood by the configuration management tool when accessed during a query.

Once the user selects the desired SB, the program may refresh the screen 201. In particular, the program may populate input section 203b with the relevant SB information. The configuration management tool may also replace the results section 205 with an output section 207. The program may populate the output section 207 with information from a query to the SB database 19. A first section 207a of the output section 207 may display parts added by the SB at the specific LID. A second section 207b of the output section 207 may display parts added by the SB at the other LIDs and which have a Sets Requirement.

As described earlier, when the maintenance facility has recognized a sourcing problem exists, the configuration management tool permits the user to find a solution to the sourcing problem and determine whether the solution is acceptable. For example, the maintenance facility may have determined that part number 50L290 has a long lead time. This long lead time may affect the ability of the maintenance facility to complete the maintenance operation on time. Specifically, the configuration management tool allows the user to determine if a suitable alternate part may be available and whether the incorporation of the alternate part into the engine may be a satisfactory solution.

The user has two options when determining the possibility of alternate parts. The user may search for an “up replacement” for the subject part or a “down replacement” for the subject part. An “up replacement” part is a part added by an SB which cancels the subject part. To use the “up replacement” part as the alternate part, the user would need to add the SB to the work scope.

A “down replacement” part is a part cancelled by an SB which adds the subject part. To use the “down replacement” part as the alternate part, the user would need to modify the work scope to reverse the work steps described in the SB.

The user can determine “up replacement” and “down replacement” parts by selecting the LID tree button in the tools box 209. The LID tree button provides a graphical representation of the “up replacements” and “down replacements” of the subject part. The configuration management tool may provide this information in a pop-up screen 301 generated by the analysis module 14.

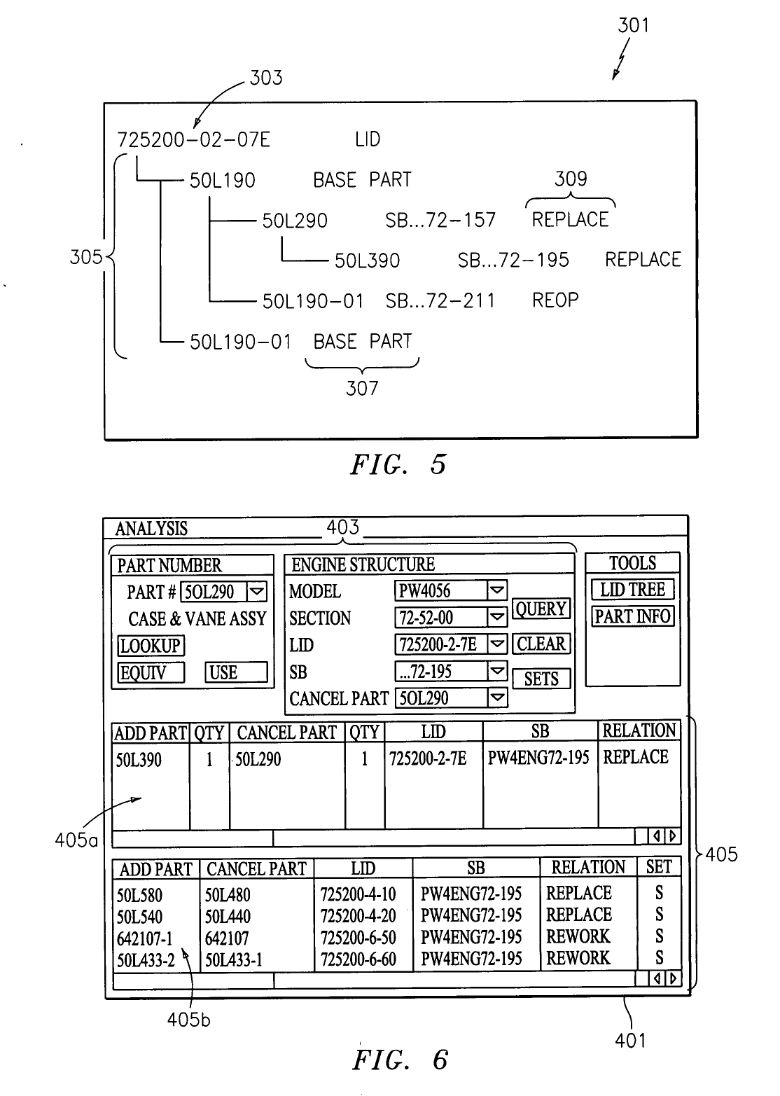

Referring now to FIG. 5, the screen 301 may provide engine location information 303, for example, LID; hierarchy information 305; incorporation information 307, for example, either displaying the SB that incorporated the part or an indication that the part is a basic part; and, operation information 309, for example, the operation the SB performs on the cancelled part. The configuration management tool obtains this information during multiple iterations of queries to the SB database 19, until the down replacement query reaches basic parts and the up replacement query finds no additional data.

Since the specific SB may affect other parts in the engine, for example, due to a Sets Requirement, the user must ensure that the use of such “up replacement” or “down replacement” alternate parts does not affect the engine configuration, does not overly complicate the maintenance operation, or does not significantly increase the price of the maintenance operation. The user determines the impact of using an “up replacement” or a “down replacement” by selecting a possible replacement part appearing in the hierarchy.

Referring now to FIG. 6, the configuration management tool will then display information regarding the possible replacement part in another pop-up screen 401. For example, the user selected part number 50L390 as the possible replacement part, and the program launches the screen 401 with this selection.

The screen 401 may resemble screen 201 of FIG. 4b. The screen 401 may include an input section 403 and an output section 405. The configuration management tool may populate the input section 403 with the information on the possible replacement part selected by the user. The configuration management tool may then query the SB database 19 for information to populate the output section 405. A first section 405a of the output section 405 may display parts added by the SB at the LID of the possible replacement part. A second section 405b of the output section 405 may display parts added by the SB at other LIDs and which have a Sets Requirement. In other words, the screen 401 may allow the user to ease the difficulty of using the possible replacement part to overcome the sourcing problem.

As seen in FIG. 6, using the “up replacement” part to avoid the sourcing problem does not appear difficult. The user may deem the use of this part as an acceptable solution. If the user does not deem the part an acceptable part or the user wishes to continue investigating, then the user may close the screen 401 and return to the screen 301 to select another possible replacement part.

Once the user has determined an appropriate solution to the unavailable part problem, the user may suggest this change to the engine owner. The engine owner may then evaluate whether the benefit of having the maintenance operation completed earlier with up or down replacement parts outweighs the cost of performing the extra SB to incorporate the up or down replacement parts.

Should the engine owner agree with the suggestion to use the up or down replacement part, the user would need to add the incorporation of such SB to the modification scope. The user adds the SB to the work scope using the planning module 12 of the configuration management tool described herein.

The maintenance facility may then utilize the auditing module 14 of the configuration management tool to consider the requisite logistics and modify the BOM, if necessary. Specifically, the maintenance facility may use the auditing module 14 to audit and modify, if necessary, the BOM in order to generate a configuration valid Planned BOM. Although, the maintenance facility may conduct the audit at any point, an audit may be conducted once a BOM is generated rather than relying upon a Grand BOM. Generally, a visual audit of approximately 25,000 engine parts is conducted which takes approximately 40 hours to complete. When utilizing the auditing module 14 of the configuration management tool described herein, the maintenance facility may conduct the audit in approximately thirty minutes.

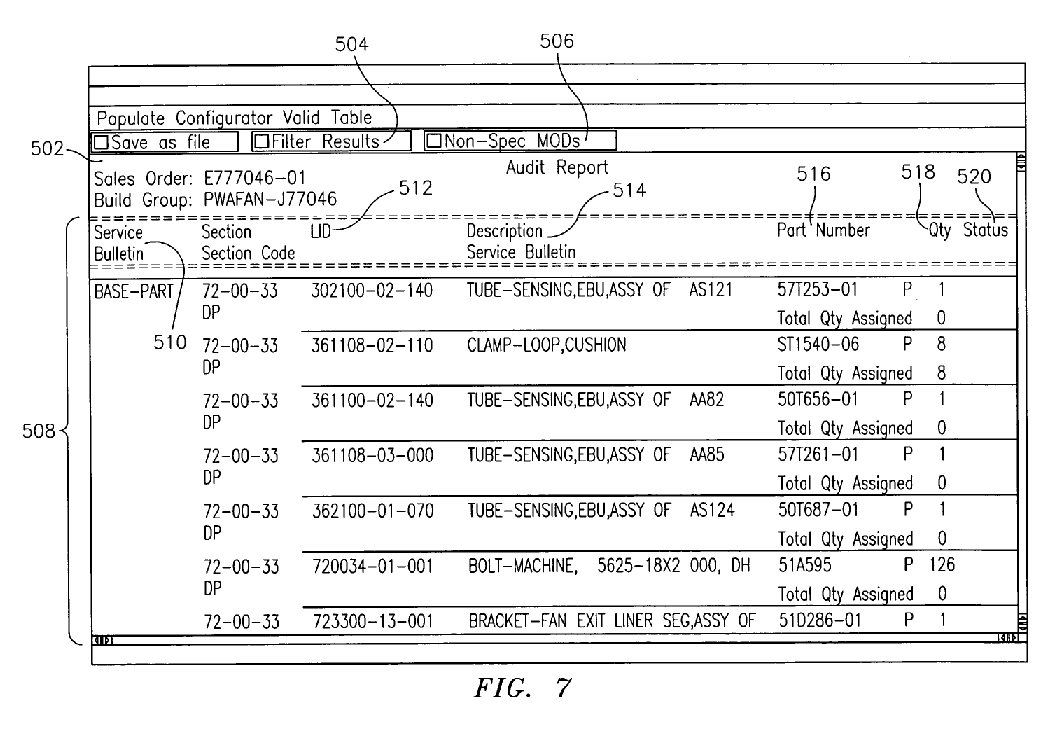

FIG. 7 displays a screen 502 generated and displayed by the auditing module 14 to assist conducting the audit by the maintenance facility 20. The screen 502 may include a filter section 504, a non-spec MODS section 406 and a results section 508. Any other suitable arrangement may be used. The various sections of the screen 502 will be described in more detail below. The results section 508 may include a service bulletin section 510, a LID section 512, a service bulletin description section 514, a part number section 516, a part number quantity 518, and a status of the assigned part section 520.

The maintenance facility may first disposition each assigned part of the engine to record the part(s) being removed and the condition of each assigned part(s) removed. Each assigned part may undergo an operation such that the assigned part's status is classified as one of the following: (1) sent out for repair; (2) scrapped and reordered; (3) undergo modification/re-operation; and, (4) approved as is, i.e., part is in good condition. The status of the assigned part may be entered in section 520 as shown in FIG. 7. The work scope, including selected service bulletins for the current overhaul process, is already entered into the planning module 12 prior to the maintenance facility receiving the engine. The service bulletins-may be listed in the service bulletin section 510 while the location of the planned part in the service bulletin may be displayed in the LID section 512. The description of the planned part at its LID and the bulletin level of the assigned part may be provided in the service bulletin description section 514. The bulletin level of the assigned part corresponds to the progression level and rank of the part according to the configuration management tool described herein as will be explained below in greater detail. The part number section 518 may identify whether the part is a planned part (“P”) or an assigned part (“A”). At this point, a complete progression may be identified from each of the base-parts to each corresponding senior MOD for each LID at a step 36 of FIG. 2.

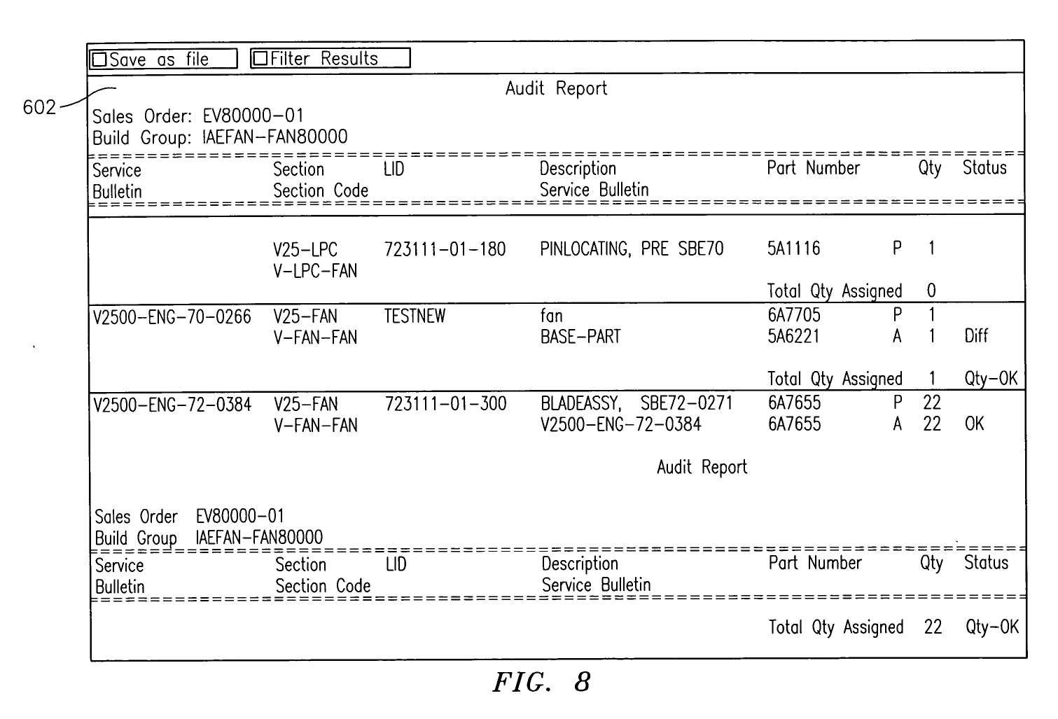

As mentioned, the maintenance facility may use the auditing module 14 to ultimately generate a configuration valid Planned BOM at step 38 of FIG. 2. FIG. 8 displays a screen 602 generated by the auditing module 14 of the configuration management tool to assist the maintenance facility in filtering the information displayed on screen 502 of FIG. 7. The maintenance facility may use the filter section 504 of screen 502 to generate screen 602 of FIG. 8 and view specific status records. One goal of engine overhaul is to make all of the engine parts serviceable within the intended turn-time, e.g., 30 to 40 days, and then release the engine into service. The auditing module 14 may quickly allow the maintenance facility to determine several factors which may affect the maintenance facility's ability to accomplish this goal.

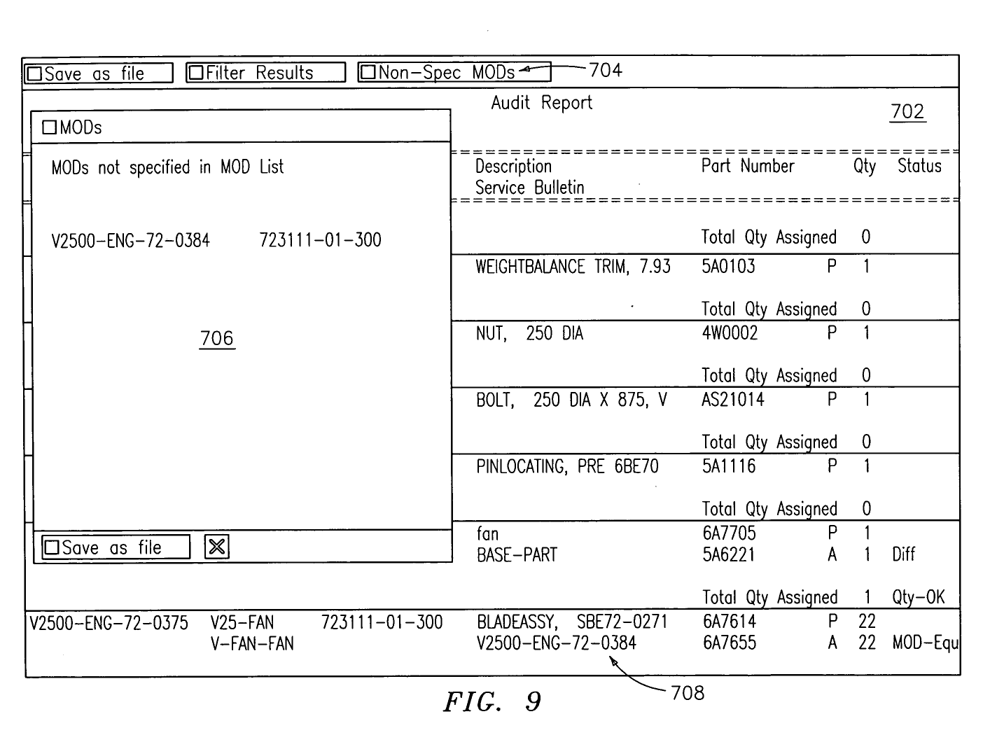

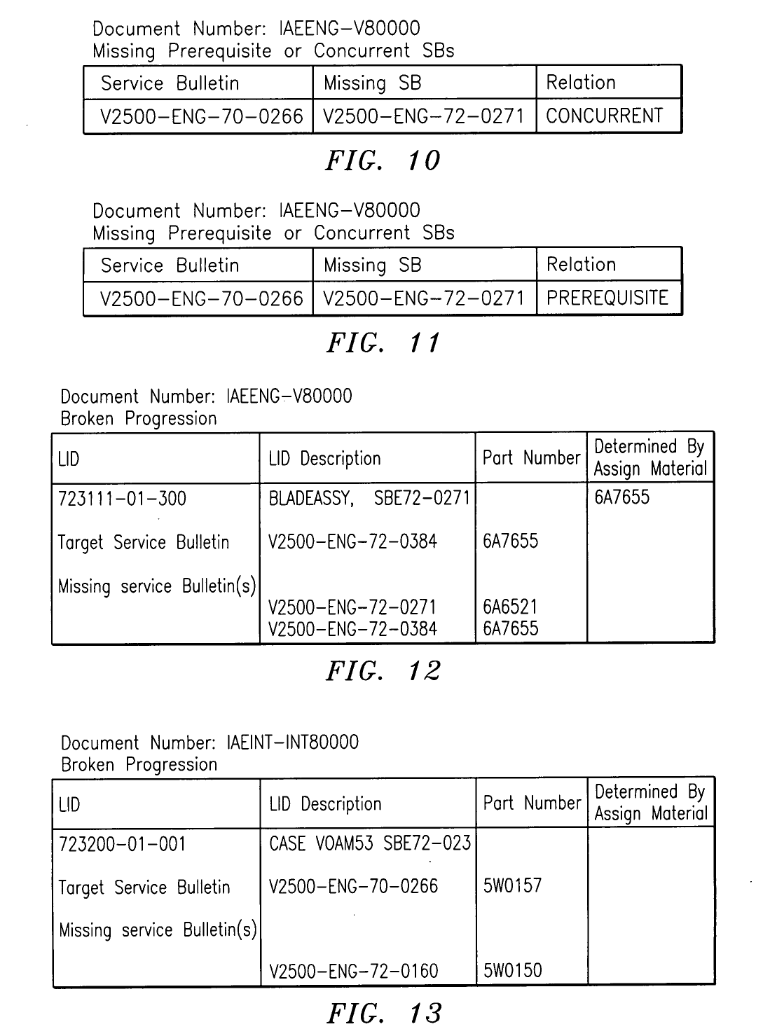

FIG. 9 displays a screen 702 generated by the auditing module 14 to assist the maintenance facility in determining whether specific service bulletin(s), and their parts, are on the MOD list. Screen 702 may incorporate a non-spec MODS section 704 which allows the maintenance facility to quickly identify service bulletins by part numbers that are not on the MOD list. For example, a non-MOD list service bulletins 706 may be identified by a symbol such as an asterisk as shown in FIG. 8. A separate graphic user interface screen 708 may be generated by activating the non-spec MODS section 704 to display the service bulletin in question. The graphic user interface screen 706 communicates to the maintenance facility the cause of the missing service bulletin. Typically, service bulletins may be missing for one of the following reasons: (1) a concurrent SB is not in the MOD list (FIG. 10); (2) a pre-requisite SB is not in the MOD list (FIG. 11); (3) a broken progression determined by assigned part number (FIG. 12); and, (4) a broken progression determined by planned part number (FIG. 13).

The maintenance facility may also quickly determine a parts' availability based upon its status in the status of the assigned part section 520 of FIG. 7. The maintenance facility may encounter a sourcing problem such as any one or more of the following situations: (1) part number may be lost; (2) part repair time exceeds turn-time; or (3) part(s) is unavailable. The maintenance facility may in turn modify the workscope in order to do one or more of the following: (1) find a suitable interchangeable part or (2) find a new or alternate part.

The auditing module 14 of the configuration management tool compares the planned part at a specific location with all of the parts dispositioned and kitted for assembly for the particular engine at that specific location. If a suitable interchangeable part(s) is found, the same service bulletin is valid and the rank and/or progression level of the bulletin is not updated at the service bulletin description section 514. If suitable interchangeable part(s) are not found, the auditing module 14 will alert the maintenance facility that the service bulletin effectivity of the part in question at that particular LID is different than the Planned BOM.

The auditing module 14 may also identify another form of configuration escape known as a “Broken Progression”, thereby preventing such events from happening during the overhaul process. If, upon discussions with the client, the maintenance facility identifies a new or alternate part which is not at the same service bulletin level as the old part, a new configuration occurs which requires an alteration to the MOD list. Consequently, the MOD list may be updated to reflect the change, a new planned BOM may be executed and the auditing module 14 may be re-executed to compare the new planned BOM to the materials already dispositioned for the engine. Any configuration discrepancies may then be highlighted by the process and apparatus of the configuration management tool described herein. Ultimately, auditing module 14 conveys a configuration valid BOM to the user once the audit is completed at step 40 of FIG. 2.

The present invention has been described in connection with the various embodiments described herein by the various figures. It is to be understood that other similar embodiments may be used or modifications and additions may be made to the described embodiment(s) for performing the same function of the configuration management tool without deviating therefrom. Therefore, the configuration management tool described herein should not be limited to any single embodiment, but rather construed in breadth and scope in accordance with the recitation of the appended claims.

One or more embodiments of the present invention have been described. Nevertheless, it will be understood that various modifications may be made without departing from the spirit and scope of the invention. Accordingly, other embodiments are within the scope of the following claims.

What is claimed is:

1. A computer-implemented process for planning a configuration valid bill of materials for a product, comprising:
inputting at least one MOD from a MOD list into a planning module to generate a part genealogy of a product;
identifying a senior MOD of said MOD list based upon a progression level value and a ranking value for at least one location identifier;
determining a shortest path in said part genealogy from at least one base-part of said product to said senior MOD for said at least one location identifier;
identifying a complete progression from each of said at least one base parts to each corresponding said at least one senior MODs for each of said at least one location identifiers;
generating a configuration valid bill of materials for said product; and
conveying said configuration valid bill of materials.

2. The process of claim 1, wherein inputting comprises inputting at least one MOD from an audited MOD list.

3. The process of claim 1, wherein inputting comprises replacing said at least one MOD with at least one new MOD.

4. The process of claim 1, further comprising removing at least one MOD from said part genealogy.

5. The process of claim 1, further comprising updating automatically said progression level value and said ranking value for each of said at least one MODs at each of said at least one location identifiers.

6. The process of claim 1, wherein determining comprises determining said senior MOD is a best fit with said at least one base part at said at least one location identifier.

7. The process of claim 1, wherein identifying further comprises the steps of:
identifying an incomplete progression from said at least one base part to a corresponding at least one senior MOD at said at least one location identifier;
determining a status of a part identified by said at least one senior MOD;
locating an interchangeable part or a new part to replace said part identified by said at least one senior MOD;
replacing said part identified by said at least one senior MOD; and
identifying said complete progression from at said least one base part to said at least one senior MOD having a replacement part at said at least one location.

8. The process of claim 1, wherein said product is a turbine engine.

9. A computer-implemented process for auditing a bill of material of a product, comprising:
dispositioning at least one serviceable part of a product;
inputting into an auditing module at least one configuration valid part as determined from a configuration valid bill of materials for said product;
determining a status of each of said at least one serviceable part and said at least one configuration valid part; and
conveying an audited MOD list.

10. The process of claim 9, wherein dispositioning comprises the steps of:
recording each of said at least one parts to be removed; and
recording a condition of each at least one removed parts.

11. The process of claim 9, wherein inputting said at least one part further comprises inputting each of said at least one parts at a location identifier of said product.

12. The process of claim 9, wherein inputting said at least one scheduled modification further comprises generating a ranking value and a progression level value for each of said at least one scheduled modifications.

13. The process of claim 12, further comprising updating automatically said progression level value and said ranking value for each of said at least one scheduled modifications at each of said at least one location identifiers.

14. The process of claim 9, wherein determining further comprises determining said at least one part requires repair.

15. The process of claim 9, wherein determining further comprises determining said at least one part requires modification.

16. The process of claim 9, wherein determining further comprises said at least one part is serviceable.

17. The process of claim 9, wherein determining further comprises the steps of:
determining said at least one part is non-serviceable;
scrapping out a non-serviceable part; and
replacing said non-serviceable part.

18. The process of claim 17, wherein replacing comprises replacing said non-serviceable part with a new part or an interchangeable part.

19. The process of claim 9, further comprising the steps of:
inputting at least one unscheduled modification into said MOD list and said auditing module; and
generating a ranking value and a progression level value for said at least one unscheduled modification.

20. The process of claim 9, wherein said product is a turbine engine.
